(19) United States
(12) Patent Application Publication
(10) Pub. No.: US 2026/0288418 A1
(43) Pub. Date: Sep. 24, 2026

(54) DETERMINING THE PROVENANCE OF ASSETS BASED ON PHASE ANALYSIS OF SOFTWARE DEVELOPMENT

(71) Applicant: SIE Consulting, Flower Mound, TX (US)

(72) Inventors: Gregory Crouse, Flower Mound, TX (US); Theodore Larson, Yukon, OK (US)

(73) Assignee: SIE Consulting, Flower Mound, TX (US)

(21) Appl. No.: 19/569,906

(22) Filed: Mar. 17, 2026

Related U.S. Application Data
(60) Provisional application No. 63/773,737, filed on Mar. 18, 2025.

(51) Int. Cl. G06F 8/10

(52) U.S. Cl. CPC G06F 8/10

(57) ABSTRACT

Methods and systems disclosed herein may be configured for acquiring one or more inputs of information, wherein the inputs of information comprise intellectual property or disclosure documentation. In addition, Methods and systems disclosed herein may be configured for analyzing a software development frameworks/software. Such analyzing may comprise hashing an attribute score from the software development frameworks/software utilizing at least the one or more inputs of information and hashing a health score from the software development frameworks/software utilizing at least the one or more inputs of information.

### BACKGROUND

Asset development (e.g. software development) is an expansive process that encompasses several phases such as designing, building, testing, deploying, and maintaining assets. For example, software assets and other programming-based assets may start with the intent of the content developer(s) that then triggers a muti-phase asset creation life cycle. Regardless of asset size, ranging from small scripts and web apps to complex enterprise systems and artificial intelligence models, content developers will rely on development framework to manage the asset development process at each phase of the life cycle. One example of a development framework is software development life cycle (SDLC). In general, development frameworks, like SDLC, provide a roadmap through the phases of software development. For example, development frameworks, whether standard or unconventional, help developers analyze the current situation resulting in a problem stated, design a solution leading to a design document, design testing leading to a “go-no go”, performing an implementation of the framework leading to generating a summary report, and perform ongoing maintenance leading to trouble tickets.

Regardless of the general framework used, assets, such as software development projects, may be associated with one or more project attributes, such as budget, costs, number or type of deliverables yielded, project size, development time, number of resources, coding language, etc. Generally, there is an expected and/or accepted range of values for certain project attributes that one might expect to see in a development framework and at each project phase, or stage, of development. The viable range of values for project attributes will vary depending on a project's size and scope. That is, the project attributes observed in the development framework for development projects using traditional programming techniques and having similar size and scope should have similar qualitative and/or quantitative values. As such, assets may be identified and categorized based on one or more project attributes by analyzing each project phase of development.

The developers and owners of software development projects may have a stake in the use and protection of the deliverables of those projects and, as a result, may desire to understand the extent that their intellectual property (IP) is acquired and used by a third-party. Currently there are no methods and systems which track and manage provenance of IP assets. In addition, there are no IP specific libraries or marketplaces where provenance and other IP assets may be exchanged or arranged. As such, a system and method for identifying an asset to verify its provenance is desirable.

### BRIEF DESCRIPTION OF THE DRAWINGS

These drawings illustrate certain aspects of some of the embodiments of the present disclosure and should not be used to limit or define the method.

FIG. 1 illustrates a schematic of a communication diagram between a processing device and a network offsite storage, in accordance with some examples.

FIG. 2 illustrates a diagram for asset health, in accordance with some examples.

FIG. 3 illustrates a diagram for verifying asset provenance, in accordance with some examples.

FIG. 4 illustrates a diagram for generating an asset identifier, in accordance with some examples.

### DETAILED DESCRIPTION

Methods and systems described herein may identify and allow a user to track when intellectual property (IP) is utilized in software development frameworks. If it is accepted that: (1) in a given asset for a field there will be comparable project attributes with another asset with a similar scope and (2) there exists certain checkpoints or stages within an asset's development (e.g., development framework), then fraud or IP theft may be identified within an asset by identifying project attributes associated with the asset at each stage of development and comparing them to known or expected project attributes of another asset. For example, one utility of such a developed model may be to use factor analysis to identify several project attributes that are consistent within known good projects. Fraud or IP theft within a given project may then be detected by comparing the project attributes (e.g., timestamps and relative cost appropriations of the various deliverables) at various checkpoints within the project framework to the known project attributes, where deviations from the known project attributes may be indicative of malfeasance.

In this manner, systems and methods described herein may allow a user to apply experience and artifacts created during a system development exercise to get a measure of implementation “health” at a point in time (e.g., the overall quality, effectiveness, and successful development and/or integration of an asset), as derived from project attributes such as project goals, plans, status reports, designs, tests, etc. Moreover, the systems and methods described herein may allow a user to measure asset “provenance,” or asses a common origin point of an asset, based on a quantification of the variation from that origin point to compare/contrast various systems given their digital footprint (e.g., code). By providing provenance assurance for developed assets, the user may identify, certify, track, and trade a developed asset based an asset identifier. Identifiers may be based on, for example, one or more known or expected project attributes. As a result, the systems and methods described herein enable a user to proactively ensure trust in code ownership, rights, payments, and licenses for content developers.

As used herein, “project attribute” may refer to any information or characteristic related to the creation of an asset that can be inferred, observed, and/or extracted in the data or metadata associated with the asset, including the asset itself and/or a component of the asset. In this manner, a project attribute may include a feature and/or quality of a developer associated with the asset, including all persons or companies involved in asset creation, in as much that such features and/or qualities influence how an asset is planned, built, tested, and deployed. For example, information related to a developer's budget, technological capability, management policy, or business model may have an impact on the asset's development framework as well as the final product of the asset. It should be noted that, in some cases, a project attribute may include ingress points throughout the development process that indicate when a portion of the asset and/or phase of development was acquired by a new or an additional developer.

As used herein, “known”, for example as in a “known asset”, may refer to an asset whose origin or attributes have been identified and/or verified, either by means disclosed herein or otherwise. As used herein, a “phase” or a “checkpoint” may refer to at least part of the overall solution and/or the framework for the developing an asset. As used herein, “deliverable(s)” may be the overall solution or product for a software and/or development framework checkpoint. As used herein, “asset” and/or “project” may be used interchangeably to refer to a physical or digital invention, the development of which is associated with a digital footprint and/or a series of development framework stages as described above. As used herein, “provenance” may refer to the origin of an asset and/or one or more attributes or sets of attributes associated with the development of the asset. Further, an “identifier” as described herein may also be referred to as a “CodeMark.” As used herein, the term “project health” may refer to the odds of successful creating the asset at a point in time (e.g., lower “health” means lower chance of asset creation).

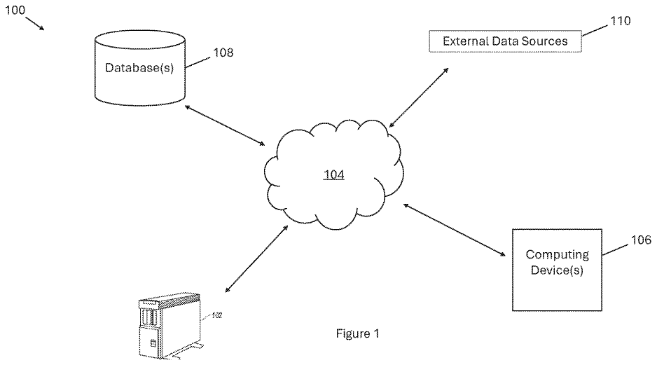

FIG. 1 illustrates a schematic of an integrated system 100, which may comprise one or more servers 102, a network 104, one or more processing devices 106, one or more database(s) 108, and one or more external data sources 110. Server 102 may be a suitable storage location for program code and data (e.g., software applications) installed on processing device 106. That is, server 102 may serve as a host that preserves and provides access to software that has been installed on processing device 106. Server 102 may further operate and function to copy and maintain all files related to the software, such as program code, data, and other documents, or may comprise a portion of the files, such as saved data or documents. Server 102 may be implemented on processing device 106 using well-known components of hardware or software. In some embodiments, information, data, and/or the like may be stored on server 102 in any type of file format. Server 102 may also employ various security features. Server 102 may communicate with processing device 106 through network 104. Network 104 may provide a communication infrastructure between each processing device 106 and server 102. Further, processing device 106 may be any computing device used by a user, such as a mobile telephone, smart-phone, devices built into an automobile, desktop computer, laptop computer, handheld computer, personal digital assistant (PDA) device, media play device, the like, or any mobile device containing one or more transistors. In some embodiments, the processing device 106 may operate to run, or otherwise provide use of and interface with, AI technology, such as a machine learning algorithm or a neural network. Database(s) 108 may be any suitable electronic data store. External data sources 110 may be one or more additional servers, networks, computing devices, databases, memory, or other suitable data storage from which data or other information may be viewed, downloaded, or extracted.

As described in detail below, integrated system 100 may operate and function to analyze one or more assets to determine asset “health” and/or verify the provenance of an asset. Such evaluations further enable objective and consistent assessment and/or detection of fraud within asset development. In an embodiment, integrated system 100 may be used to facilitate assessment of project “health” at a given point in time. That is, before or during development of an asset, the health of the development project may be evaluated based on project attributes (e.g., expected or real) at one or more phases of development.

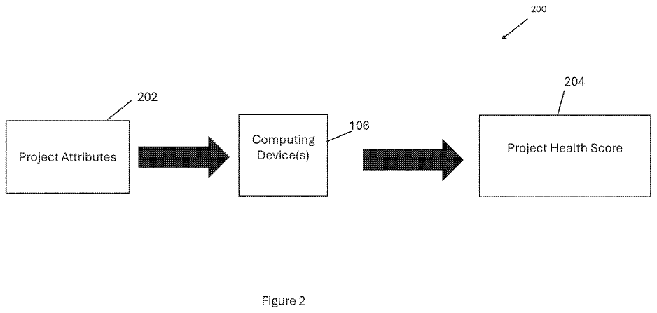

FIG. 2 illustrates a diagram 200 for ascertaining project “health.” Operations for project health may be performed, for example, via one or more components of integrated system 100. Project attributes 202 may by identified and used as input for analysis. In some embodiments, as shown in FIG. 2, analysis may be performed via a computing device 106. Project attributes 202 may be retrieved, extracted, viewed, downloaded, and/or consolidated onto the computing device 106 for assessment. For example, project attributes 202 may be identified and analyzed to predict a project's likelihood of yielding the intended asset and/or to reveal how an asset was created. In this sense, project attributes 202 may be understood as the “blueprint” for an asset project and/or the “paper trail” for an asset's creation, including the final product asset itself and/or the documents, artifacts, or information created and/or used during the creation of the asset. For example, project attributes 202, may comprise, but are not limited to, project costs, scale, design, tests, timeline, expected or actual time duration for each project phase, and/or other logistics, including those regarding the process, people, and management of an organization associated with the development of the asset. In this manner, project attributes 202 may comprise, for example, artifacts and/or information regarding an organization's workflow, technology infrastructure, reporting procedures, training procedures, employee turnover rate, organization change management procedures, and/or WRICEF procedures. Such project attributes 202 may comprise metrics that impact an organization's ability to achieve the end-goal of the development project in the manner in which it set out to do. Project health score 204 may be indicative of this ability and/or may be predictive of a project's likelihood of success at a given point in time. In this manner, analysis of project attributes 202 may yield an overall project health score 204, as shown in FIG. 2.

Project attributes 202 may be downloaded, extracted, retrieved, or otherwise obtained from the one or more databases 108, one or more external data sources 110, or, in some cases, directly from the associated organization. In some embodiments, one or more additional project attributes 202 may be identified via analysis of obtained project attributes 202. For example, attributes such as a project's design and scale obtained from external data source 110 may be reviewed and researched to identify additional attributes such as a project's timeline or time duration during each phase of development or an organization's technological infrastructure. In this manner, project attributes 202 may be both input and output and may be reconfigured to solve for any parameter related to project health score 204.

In some embodiments, integrated system 100 may operate to verify asset provenance. That is, system 100 may be used to compare project attributes of two assets to determine if a first asset (and associated project attributes), such as a known software program, was used or relied upon to develop a second asset. In some cases, the project attributes of two assets may be extracted, identified, and analyzed according to method disclosed herein and then directly compared to identify similarities between the two assets. In this manner, potential fraud, such as unauthorized copying of an asset, may be ascertained not just by mere comparison of asset code or appearance or overt function; rather, by evaluating asset project attributes, comparison between assets may be performed on a granular level, thereby enabling identification of instances of covert or subtle IP theft. In some cases, comparison of project attributes between two or more assets may be represented in graphical form. By plotting attributes in a graph or other visual format, any overlap between assets may be observed. For example, graphing out time spent on asset design/build/test may allow identification of a healthy/unhealthy asset or otherwise assist a person to identify which asset is the original and which asset is stolen. Comparison of assets and project attributes is described in additional detail below.

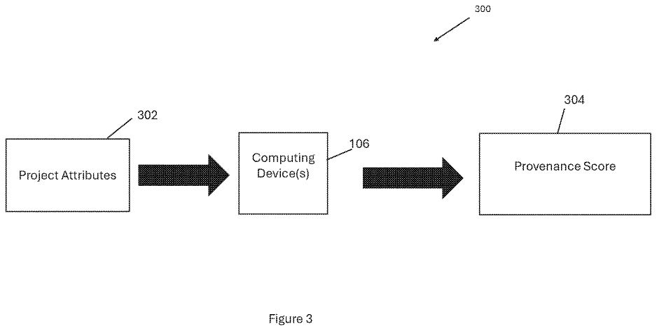

FIG. 3 illustrates a diagram 300 for verifying asset provenance. Operations for verifying provenance may be performed, for example, via one or more components of integrated system 100 in a manner similar to that described above with respect to FIG. 2. Project attributes 302 for verifying provenance may comprise, but are not limited to, asset design (style, time, type), build (time, type, style), and testing (time, type, style), as well as knowledge-driven development associated with the asset, functional design specification associated with the asset, and/or other metrics indicative of an asset's origin and development. In some embodiments, project attributes 302 may be analyzed via one or more data mining techniques to determine if AI was used during any stage of development. Further, similar to project attributes 202 described above, project attributes 302 may serve as both input and output during analysis in that they may contain, imply, or otherwise lead to one or more additional project attributes and, therefore, may be reconfigured to solve for any parameter related to provenance score 304. That is, for example, obtained project attributes 302 indicative of asset design (e.g., style and look of a user interface) may be further evaluated or researched to ascertain one or more additional project attributes 302 indicative of a time when the asset design first appears (either within the project development framework or in an external data source), a person associated with the design (either within the project development framework or in an external data source), a code associated with the design, a source of the design code, or other factors indicative of the origin of the obtained design attribute.

In this manner, project attributes 302 during one or more phases of development may be analyzed and evaluated to determine the “fingerprint” of each asset, or unique identification of each asset. The unique identification of an asset may enable evaluation of the overall origin or provenance of an asset throughout its creation. The assessment of an asset's origin may be represented by the provenance score 304. Provenance score 304 may be generated by any suitable scoring or classification means where the output value (e.g., either qualitative or quantitative) is representative of the origin of an asset's attributes. Examples of suitable scoring systems may comprise, but are not limited to, an unevaluated timeline, a rubric system, a sliding scale system, an empirical value system, or any other suitable scoring system that has internally or externally normalized values. In some embodiments, provenance score 304 may be part of a provenance profile associated with an asset, where the profile comprises additional origin information such as a chain of knowledge transfer, a development timeline, percent similarities with other known projects, and/or other graphics or scores indicative of asset provenance.

The ability to objectively and consistently determine an asset's “health” and/or provenance provides numerous practical benefits for content developers. For example, content developers and/or owners of physical and digital assets have a stake in the use and protection of the deliverables of those projects and, as a result, may desire to understand the likelihood of their asset's success and/or the extent their asset is used in third-party project development frameworks. As such, the above-described system and method for assessing project health and verifying the provenance of an asset is desirable. With regard to FIG. 3 in particular, systems and methods described herein enable a user to classify and identify an asset based on one or more project attributes as a means of verifying the provenance of the asset. Representative of this provenance is the provenance score 304, which may be used to identify instances of fraud, IP theft, or unauthorized copying of an asset and/or its project attributes.

For example, when searching for indicators of fraud and/or used intellectual property (IP) within an asset, the deliverables at each phase (e.g., stage, checkpoint) of the asset's development framework may be assessed and analyzed. As discussed above, regardless of the development framework used during asset creation, each development phase may be associated with one or more project attributes 302. Further, each project attribute may be associated with a valid range of values, depending on the project size and scope. In an embodiment, such values may be “hashed” to create a unique and comparable identifier (e.g., a “CodeMark”) indicative of an asset's attributes and, therefore, its “health” and/or provenance. That is, a project identifier may be indicative of an asset's provenance, where asset provenance is based on one or more of the asset's project attributes. Asset identifiers may be used during analysis (e.g., forensic analysis) of other assets to determine if the other asset contains an asset and/or project attribute belonging to another, either in whole or in part. In some embodiments, analysis of an asset using asset identifiers may comprise direct comparison of two asset identifiers. In this manner, systems and methods disclosed herein may incorporate development analytics, systems implementation analytics, software development life cycle (SDLC) fingerprinting, and/or SDLC profiling.

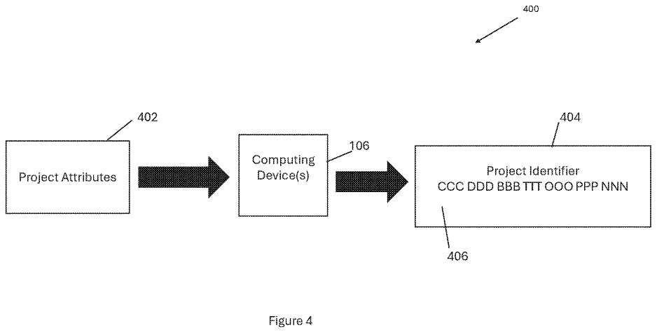

FIG. 4 illustrates a diagram 400 for generating an asset identifier based on input project attributes 402. Operations for generating an asset identifier may be performed, for example, via one or more components of integrated system 100 in a manner similar to that described above with respect to FIGS. 1 and 2. As shown in FIG. 4, identifier 404 may comprise a series of two or more characters (e.g., X7K9-P2M4-Q8R1-T5V3-Y9N2-Z1B6). In an embodiment, the identifier 404 may be as long as 24-characters. In an embodiment, the identifier 404 may be as long as 48-characters. The characters may comprise number, roman letters, or a combination thereof. In some embodiments, the identifier may be made tamper-proof. For example, the identifier may comprise a digital signature and/or a timestamp. Additionally or alternatively, the identifier 404 may be implemented in a tamper-proof blockchain.

As previously discussed, the identifier 404 may be indicative of asset origin and/or implementation health and is determined based on one or more project attributes 402. Input project attributes 402 may comprise any information compiled in and/or derived from a development framework associated with the asset, including, for example, project cost, schedule, duration, turnover, OCM/change, WRICEFs, time per phase, and/or data regarding the number of people who worked on an asset, the roles of each person who worked on an asset, a company or business associated with the asset and that company's standards, experiences, practices applied during asset development, research performed in connection with asset development, requirements issues, test issue/profile/score, training issues, technology infrastructure, development health, and/or the like. As such, data regarding any or all of the potential project attributes may serve as input 402 for generating the project identifier 404. In a similar manner as that discussed above, the identifier 404, or “hash,” for a given asset conveys information regarding asset development and, as such, is representative of asset health and provenance.

As shown in FIG. 4, each character and/or set of characters 406 of identifier 404 may be based on and/or represent one or more project attributes associated with the asset. As described above, a project attribute may comprise any aspect associated with developing the asset, including, but not limited to, design elements and corresponding components or digital constructs (e.g., code, images, 3D printer code, music) and/or any associated metadata. In this manner, the identifier may be referred to as a “smart hash” in that each character in the identifier has meaning or value. In this way, each character or set of characters 406 in identifier 404 may be associated with a particular attribute and/or phase of development such that the order of the characters may convey a defined set of information. For example, in an embodiment, a first character, or a first set of characters, in identifier 404 may represent a classification or type of asset (e.g., code/music/image) and all the characters would be used to not only uniquely identify the digital asset. In the same embodiment, a second character, or a second set of characters, in identifier 404 may represent design attributes, a third set of characters may represent build attributes, a fourth set of characters may represent test attributes, and so on. In some embodiments, one or more characters or sets of characters may be designated to represent a taxonomy classification for the asset (e.g., 3d printer code, SAP code, Python code, etc.) and/or ownership (e.g., MSFT IDE owned by IBM/SAP IDE owned by Ford/Bangalore hacker #123). In this way, an asset may be efficiently and reliably identified based on the generated hash, since the hash value directly corresponds to specific and unique project attributes associated with the asset.

The above-described system and method for assessing project health and verifying the provenance via a asset identifier enables objective and consistent assessment and/or detection of fraud within asset development. For example, a project goal may be “for every month saved in development you save on average $10 million.” A person may compare project attributes by comparing health scores, provenance scores, or asset identifiers. If comparing health scores, a person may improve this score by, for example, adding more trainers, improving technology infrastructure, adjusting asset design, scaling down, etc. If before a project had 20 trainers for 6,000 people, the health score may suggest a project is short on training, so adding more people may improve the score and subsequently increase the projects likelihood of success. Similarly, by using an asset identifier (i.e., “hash”), a person is able to see all at once the important project attributes associated with an asset and directly compare them with those of another asset. In this manner, a person may see their asset's potential within its own development and compare against other similar assets. For example, this may be performed by comparing two files by how similar they are. Such comparison may also be performed to determine a degree of similarity between assets and, as such, potentially detect unauthorized reuse of pre-existing assets. As such, examining the hash itself (against other hashes or alone) and determining if the underlying hashed file is novel, or derived through some known technology artifact (e.g., so if it's 90% open source, that would leave 10% potentially novel).

Benefits of the systems and methods disclosed herein comprise improvements in IP litigation. In an example, Company B Alleges Company A of software trade secret theft. No code or artifacts have been transferred between the companies. Examined “known good” artifacts and basic technology constructs with the allegedly stolen artifacts, along with the time expended in creating these artifacts may convey important meanings. Herein, stolen artifacts may or may not comprise direct transfer or any form of indirect transfer. In addition, it may comprise theft, infringement, or any other non-consensual activity or use of any form of copyright, patent, trade secret, trademark, or any other document, concept, property a party does not have privilege to use or access. For example, a party may show there was no evidence of trade secret theft given the similarity between the accepted and publicly known artifacts and the allegedly copied artifacts being rendered “obvious.” In addition, the resources and time invested into relevant inquires may form checkpoints detailing how a company structured its software and/or development frameworks. Further, this may assist communication between the authors. For example, if one author is an expert at legal terminology, and the other is not important misphrasings may occur. Some of the outcomes in a follow-up may be redacted, based on confidentiality. In addition, systems and methods may be related to preponderance of evidence, rather than scientific repetition. However, our current presumption is that both thresholds may be met through the same model.

Systems and methods described herein may issue certificates such as Secure Sockets Layer (SSL) certificates and issue authority over the ‘prints’. In examples, leveraging this method against other digital mediums that may be classified, music, movies, books with the result being no two hashes of each medium would be the same. In this example, each hash may indicate its provenance. Further methods and systems disclosed herein may calculate a hash or checksum that represents the mathematical representation of the unique identification of the SDLC (e.g., “SDLC profile/pattern/fingerprint” or “SDLC profiling”). As such, systems and methods may manage certificates for software Intellectual Property (IP) holders. This may yield approval or “good housekeeping” stamp for software saying its free from IP theft.

Systems and methods described herein may combine forensics capabilities to enhance the print as it relates to matching patterns, determining volumes and functions of code. Further, systems and methods described herein may leverage experience, artifacts, prior art, and/or the like to ascertain or value the concepts—weather they be expressive, functional, generic, open source, public domain, trade secret to enhance the unique identification of an asset. As such, there is a taxonomy/classification of prints possible. Systems and methods described herein may consider prior art concepts (patents, academia, products) to assess the value (both functionally and financially) of the concepts employed—in addition to “weight,” hash may have “value.” Systems and methods described herein may add specific knowledge, artifacts, architecture componentry, into the SDLC hash. One method is cost per month—such as getting to cost/spend to build type analysis.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. It is also to be understood that the terminology used herein is for the purpose of describing particular embodiments only and is not intended to be limiting. As used herein, the singular forms “a”, “an”, and “the” comprise singular and plural referents unless the content clearly dictates otherwise. Furthermore, the word “may” is used throughout this application in a permissive sense (i.e., having the potential to, being able to), not in a mandatory sense (i.e., must). The term “comprise,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure comprises any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

Improvements disclosed herein may reflect methods and systems configured to identify and allow a user to track when intellectual property (IP) is utilized in software development frameworks. If it is accepted that: (1) in a given asset for a field there will be comparable project attributes with another asset with a similar scope and (2) there exists certain checkpoints or stages within an asset's development (e.g., development framework), then a model may be developed to identify fraud or IP theft within an asset by identifying project attributes associated with the asset at each stage of development and comparing them to known or expected project attributes of another asset. For example, one utility of such a developed model may be to use factor analysis to identify several project attributes that are consistent within known good projects. Fraud or IP theft within a given project may then be detected by comparing the project attributes (e.g., timestamps and relative cost appropriations of the various deliverables) at various checkpoints within the project framework to the known project attributes, where deviations from the known project attributes may be indicative of malfeasance.

The above-disclosed improvements may be extended to allow a user to apply experience and artifacts created during a system development exercise to get a measure of implementation “health” (e.g., the overall quality, effectiveness, and successful development and/or integration of an asset), as derived from project attributes such as project goals, plans, status reports, designs, tests, etc. Moreover, the systems and methods described herein may allow a user to measure asset “provenance,” or assess a common origin point of an asset, based on a quantification of the variation from that origin point to compare/contrast various systems given their digital footprint (e.g., code). By providing provenance assurance for developed assets, the user may identify, certify, track, and trade a developed asset based an asset identifier. Identifiers may be based on, for example, one or more known or expected project attributes. As a result, the systems and methods described herein enable a user to proactively ensure trust in code ownership, rights, payments, and licenses for content developers. The above-described methods and systems are not well-understood, routine, or conventional in the relevant technical field. To illustrate, practitioners in the field did not routinely implement improvements of methods and systems described above in relation to provenance was described in standard references, textbooks, or widely deployed commercial systems.

The methods and systems may comprise any of the various features disclosed herein, including one or more of the following statements.
Statement 1. A method comprising determining a development framework of an asset, wherein the development framework comprises one or more project phases; and determining whether there is one or more instances of fraud within the development framework of the asset based on a set of project attributes, comprising: obtaining one or more inputs of information, wherein the one or more inputs of information comprise the set project attributes; and verifying a provenance of the asset based on the one or more inputs, wherein the provenance is indicative of an origin of one or more attributes of the set of attributes, an origin of the asset, or both.
Statement 2. The method of Statement 1, wherein each project attribute in the set of project attributes is associated with a project phase of the one or more project phases.
Statement 3. The method of any preceding Statement, wherein determining whether there is one or more instances of fraud further comprises determining one or more additional project attributes based on the set of project attributes.
Statement 4. The method of any preceding Statement, wherein verifying the provenance of the asset comprises hashing a project identifier associated with the asset utilizing at least the one or more inputs of information.
Statement 5. The method of any preceding Statement, wherein the project identifier is indicative of the provenance of the asset.
Statement 6. The method of any preceding Statement, wherein the project identifier is a quantitative representation of the one or more project phases.
Statement 7. The method of any preceding Statement, wherein verifying the provenance of the asset comprises comparing the project identifier with one or more additional project identifiers forming a comparison, wherein the one or more additional project identifiers are associated with one or more additional assets.
Statement 8. The method of any preceding Statement, comprising detecting an instance of fraud within the development framework based on the comparison.
Statement 9. The method of any preceding Statement, evaluating implementation health associated with the asset; and generating a health score based on the evaluation.
Statement 10. The method of any preceding Statement, wherein the health score is indicative of a likelihood of success associated with the asset, wherein success is based on achieving one or more goals associated with asset development.
Statement 11. A method, comprising determining a plurality of project attributes associated with an asset; generating a project identifier associated with the asset based on the plurality of project attributes, wherein the project identifier is indicative of a provenance of the asset; and performing one or more forensic techniques utilizing the project identifier to predict a likelihood of whether a crime was committed during development of the asset.
Statement 12. The method of Statement 11, wherein one or more project attributes of the plurality of project attributes is associated with one or more phases of development of the asset.
Statement 13. The method of Statement 11, wherein the project identifier comprises a series of 24 or more characters.
Statement 14. The method of Statement 13, wherein the series of 24 or more characters comprises one or more sets of characters, wherein each set of characters corresponds to a respective phase of development of the asset.
Statement 15. The method of Statement 14, wherein each set of characters quantifies at least one project attribute of the plurality of project attributes, wherein the at least one project attribute is associated with the respective phase of development.
Statement 16. The method of Statement 11, wherein performing one or more forensic techniques comprises comparing the project identifier to at least one other project identifier.
Statement 17. The method of Statement 11, comprising determining a percent of similarity between the asset and at least one other asset based on the plurality of project attributes.
Statement 18. The method of Statement 11, wherein at least some project attributes of the plurality of project attributes are obtained from one or more databases.
Statement 19. The method of Statement 11, wherein at least some project attributes of the plurality of project attributes are obtained from an organization associated with the asset.
Statement 20. The method of Statement 11, wherein at least some project attributes of the plurality of project attributes are determined based on one or more data mining methods.

What is claimed:

1. A method comprising:
determining a development framework of an asset, wherein the development framework comprises one or more project phases; and
determining whether there is one or more instances of fraud within the development framework of the asset based on a set of project attributes, comprising:
obtaining one or more inputs of information, wherein the one or more inputs of information comprise the set of project attributes; and
verifying a provenance of the asset based on the one or more inputs, wherein the provenance is indicative of an origin of one or more attributes of the set of attributes, an origin of the asset, or both.

2. The method of claim 1, wherein each project attribute in the set of project attributes is associated with a project phase of the one or more project phases.

3. The method of claim 1, wherein determining whether there is one or more instances of fraud further comprises determining one or more additional project attributes based on the set of project attributes.

4. The method of claim 1, wherein verifying the provenance of the asset comprises hashing a project identifier associated with the asset utilizing at least the one or more inputs of information.

5. The method of claim 4, wherein the project identifier is indicative of the provenance of the asset.

6. The method of claim 4, wherein the project identifier is a quantitative representation of the one or more project phases.

7. The method of claim 4, wherein verifying the provenance of the asset comprises comparing the project identifier with one or more additional project identifiers forming a comparison, wherein the one or more additional project identifiers are associated with one or more additional assets.

8. The method of claim 7, comprising detecting an instance of fraud within the development framework based on the comparison.

9. The method of claim 1, comprising:
evaluating implementation health associated with the asset; and
generating a health score based on the evaluation.

10. The method of claim 9, wherein the health score is indicative of a likelihood of success associated with the asset, wherein success is based on achieving one or more goals associated with asset development.

11. A method, comprising:
determining a plurality of project attributes associated with an asset;
generating a project identifier associated with the asset based on the plurality of project attributes, wherein the project identifier is indicative of a provenance of the asset; and
performing one or more forensic techniques utilizing the project identifier to predict a likelihood of whether a crime was committed during development of the asset.

12. The method of claim 11, wherein one or more project attributes of the plurality of project attributes is associated with one or more phases of development of the asset.

13. The method of claim 11, wherein the project identifier comprises a series of 24 or more characters.

14. The method of claim 13, wherein the series of 24 or more characters comprises one or more sets of characters, wherein each set of characters corresponds to a respective phase of development of the asset.

15. The method of claim 14, wherein each set of characters quantifies at least one project attribute of the plurality of project attributes, wherein the at least one project attribute is associated with the respective phase of development.

16. The method of claim 11, wherein performing one or more forensic techniques comprises comparing the project identifier to at least one other project identifier.

17. The method of claim 11, comprising determining a percent of similarity between the asset and at least one other asset based on the plurality of project attributes.

18. The method of claim 11, wherein at least some project attributes of the plurality of project attributes are obtained from one or more databases.

19. The method of claim 11, wherein at least some project attributes of the plurality of project attributes are obtained from an organization associated with the asset.

20. The method of claim 11, wherein at least some project attributes of the plurality of project attributes are determined based on one or more data mining methods.
